(19) United States
(12) Patent Application Publication
(10) Pub. No.: US 2012/0161475 A1
(43) Pub. Date: Jun. 28, 2012

(54) VEHICLE BODY STRUCTURE

(75) Inventor: Takeo Mori, Susono-shi (JP)

(73) Assignee: TOYOTA JIDOSHA KABUSHIKI KAISHA, Toyota-shi (JP)

(21) Appl. No.: 13/394,360

(22) PCT Filed: Sep. 14, 2009
(86) PCT No.: PCT/JP2009/066027

§ 371 Date: Mar. 6, 2012

(51) Int. Cl. B62D 25/04; B62D 25/00

(52) U.S. Cl. 296/193.06; 296/187.01

(57) ABSTRACT

Provided is a vehicle body structure that can increase the strength of desired positions in skeleton constituent members and improve shock-absorbing performance, without causing an increase in the weight of a vehicle. A vehicle body structure includes a front pillar, a center pillar, a roof side rail, and a side sill. A center pillar patch R/F is provided as a first reinforcing portion at a belt line portion of a front pillar outer R/F in the front pillar. Additionally, a high plate-thickness portion is formed as a second reinforcing portion over a region broader than a region including the center pillar patch R/F. Moreover, a high-strength portion is formed as a third reinforcing portion over a region broader than a region including the high plate-thickness portion.

### TECHNICAL FIELD

The present invention relates to a vehicle body structure pertaining to a skeletal structure of a vehicle.

### BACKGROUND ART

As skeleton constituent members that constitute the skeletal structure of a vehicle, a front pillar, a center pillar, a roof side rail, a side sill outer, and the like are used. Among these, the front pillar is provided at the front of the vehicle. Additionally, the center pillar is provided at a central portion of the vehicle in its front-back direction. Moreover, the roof side rail is provided at a high portion of the vehicle. The side sill is provided at a lower part of the vehicle.

These skeleton constituent members often require a reinforcing structure for absorbing shock generated due to a collision or the like of the vehicle. As such a reinforcing structure, in the related art, a center pillar provided with a reinforcing member is known (for example, refer to Patent Document 1). In this center pillar, an upper member, a central member, and a lower member are made of high-tension steel sheets. Additionally, the tensile strength of the upper member is made lower than the tensile strength of the central member, and is made higher than the tensile strength of the lower member. Through such a configuration, variation in residual stress becomes small, the amount of deformation caused by a camber knuckle or the like is reduced, and shape accuracy is improved. Thus, press working becomes easy.

### CITATION LIST

### Patent Literature

[Patent Document 1] Japanese Unexamined Patent Application Publication No. JP-A-2009-001121

### SUMMARY OF INVENTION

### Technical Problem

In the center pillar disclosed in the above Patent Document 1, the tensile strengths of the upper member, the lower member, and the central member are made different from each other. For this reason, the skeleton constituent members can be reinforced in order to absorb the shock generated due to the collision or the like of the vehicle. However, in order to make the tensile strengths of the respective members of the center pillar different from each other, it is necessary to use many members including the upper member, the lower member, and the central member. For this reason, there is a problem in that the number of parts, such as parts that constitute a reinforcing member, increases and an increase in the weight of the vehicle becomes larger by that amount.

Thus, an object of the invention is to provide a vehicle body structure that can increase the strength of desired positions in skeleton constituent members and improve shock-absorbing performance, without causing an increase in the weight of a vehicle.

### Solution to Problem

In order to solve the above problems, a vehicle body structure related to the invention includes a skeleton constituent member that constitutes a vehicle body skeleton. A reinforcing portion is formed at an intermediate portion of the skeleton constituent member. The skeleton constituent member is reinforced over a region including the reinforcing portion and broader than the reinforcing portion. The strength of the skeleton constituent member has a strength distribution that changes in a plurality of steps.

In the vehicle body structure related to the invention, the skeleton constituent member is reinforced. For this reason, the strength of a desired position in the skeleton constituent member can be increased. Moreover, a reinforcing portion is formed at an intermediate portion of the skeleton constituent member when the skeleton constituent member is reinforced, the skeleton constituent member is reinforced over a region including the reinforcing portion and broader than the reinforcing portion, and the strength of the skeleton constituent member has a strength distribution that changes in a plurality of steps. For this reason, since the reinforcing portion can be used in an overlapping manner in reinforcing a desired position of the skeleton constituent member, an increase in the number of parts for reinforcement can be prevented. Accordingly, the strength of a desired position in the skeleton constituent member can be increased and shock-absorbing performance can be improved, without causing an increase in the weight of a vehicle.

Here, it is possible to adopt an aspect in which the vehicle body structure further includes a first reinforcing portion formed at the intermediate portion of the skeleton constituent member, a second reinforcing portion formed over a region including a first reinforcing portion forming region formed with the first reinforcing portion and broader than the first reinforcing portion forming region, and a third reinforcing portion formed over a region including a second reinforcing portion forming region formed with the second reinforcing portion and broader than the second reinforcing portion forming region.

By forming the first reinforcing portion, the second reinforcing portion, and the third reinforcing portion in this way, the number of parts for reinforcement can be efficiently reduced. As a result, the strength of desired positions in skeleton constituent members can be increased and impact-absorbing performance can be improved, more appropriately without causing an increase in the weight of the vehicle.

Additionally, it is possible to adopt an aspect in which the first reinforcing portion is reinforced by providing a reinforcing member, the second reinforcing portion is reinforced by making the plate-thickness thereof larger than that of other portions, and the third reinforcing portion is reinforced by heat treatment.

By forming the first reinforcing portion, the second reinforcing portion, and the third reinforcing portion in this way, these reinforcing portions can be appropriately formed.

Moreover, it is possible to adopt an aspect in which the skeleton constituent member includes a plurality of portions, and a weakened portion is formed at a joining portion between one skeleton constituent member and another skeleton constituent member.

By forming the weakened portion in this way, a portion between the respective skeleton constituent members can be stably deformed. Moreover, even in a portion having a complicated shape, the weakened portion can be easily formed.

Otherwise, it is possible to adopt an aspect in which the skeleton constituent member includes a front pillar and a side sill, and a weakened portion is formed in a region covering both members of the front pillar and the side sill on the vehicle front side.

As the weakened portion is formed in a region covering both members of the front pillar and the side sill on the vehicle front side, even when a front collision occurs in a vehicle and a tire interferes with the front pillar and the side sill, the front pillar and the side sill can be appropriately deformed. As a result, collision absorption performance can be made high.

Moreover, it is possible to adopt an aspect in which the skeleton constituent member includes a center pillar and a side sill, and a weakened portion is formed on the vehicle body lower side of a region of the side sill where the center pillar is disposed.

As the weakened portion is formed on the vehicle body lower side of a region of the side sill where the center pillar is disposed in this way, when a side collision occurs in a vehicle, the side sill and a lower portion of the center pillar can be appropriately deformed. As a result, the bending moment that acts on the side sill can be reduced and the deformation amount of the skeleton constituent members can be suppressed.

### Advantageous Effects of Invention

According to the vehicle body structure related to the invention, the strength of a desired position in the skeleton constituent member can be increased and shock-absorbing performance can be improved, without causing an increase in the weight of a vehicle.

### BRIEF DESCRIPTION OF DRAWINGS

FIG. 1 is a perspective view of a vehicle body structure related to an embodiment of the invention.

FIG. 2 is an exploded perspective view of a front pillar and a roof side rail.

FIG. 3 is an exploded perspective view of a center pillar and a side sill.

FIG. 4A is a perspective view showing the vicinity of the front pillar when a front collision occurs in a vehicle, and FIG. 4B is a perspective view showing the vicinity of the roof side rail when a side collision occurs in the vehicle.

FIG. 5A is a perspective view showing the vicinity of the center pillar when a side collision occurs in a vehicle, and FIG. 5B is a perspective view showing the vicinity of the side sill when a side collision occurs in the vehicle.

### DESCRIPTION OF EMBODIMENTS

An embodiment of the invention will be described below with reference to the accompanying drawings. In addition, in the description of the drawings, the same reference numerals will be given to the same elements, and duplicate description will be omitted. Additionally, for convenience of illustration, the scale of the dimensions in the drawings do not necessarily coincide with those described.

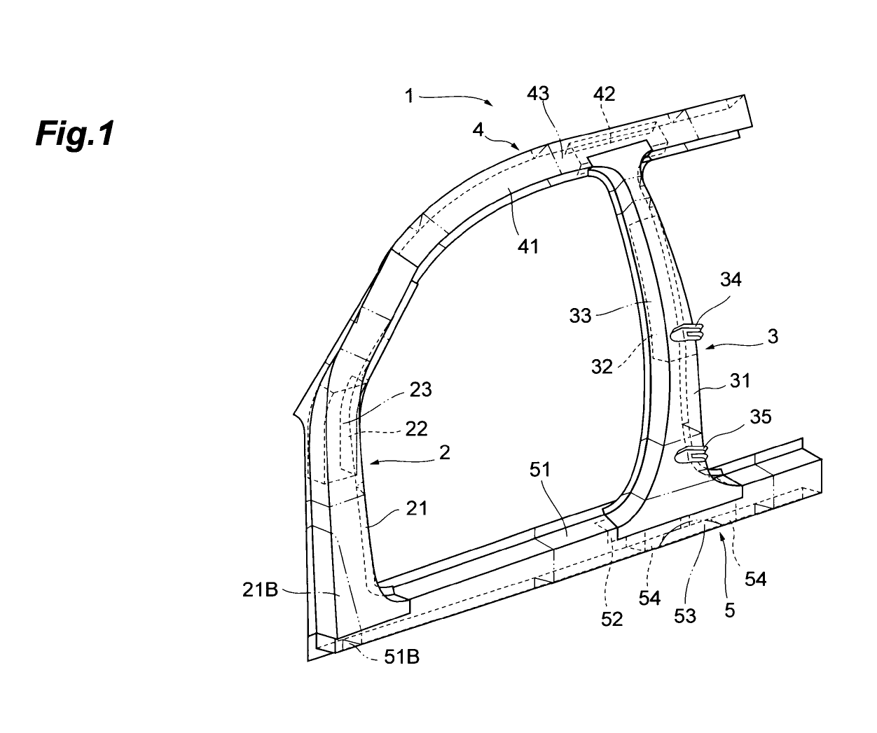

FIG. 1 is a perspective view of a vehicle body structure related to an embodiment of the invention. As shown in FIG. 1, a vehicle body structure 1 related to the present embodiment includes a front pillar 2, a center pillar 3, a roof side rail 4, and a side sill 5 that are skeleton constituent members as a side member structure. The front pillar 2 and the center pillar 3 extend substantially in the vertical direction, the front pillar 2 is arranged at a front part of a vehicle including the vehicle body structure 1, and the center pillar 3 is arranged substantially at a central portion of the vehicle in the front-back direction. Additionally, the roof side rail 4 and the side sill 5 extends substantially in the front-back direction of the vehicle, and the roof side rail 4 is arranged at an upper part of the vehicle, and the side sill 5 is arranged at a lower part of the vehicle.

Additionally, an upper end of the front pillar 2 is joined to a tip portion of the roof side rail 4, and a lower end of the front pillar 2 is joined to a tip portion of the side sill 5. Moreover, an upper end of the center pillar 3 is joined to a middle position of the roof side rail 4 in the length direction, and a lower end of the center pillar 3 is joined to a middle position of the side sill 5 in the length direction.

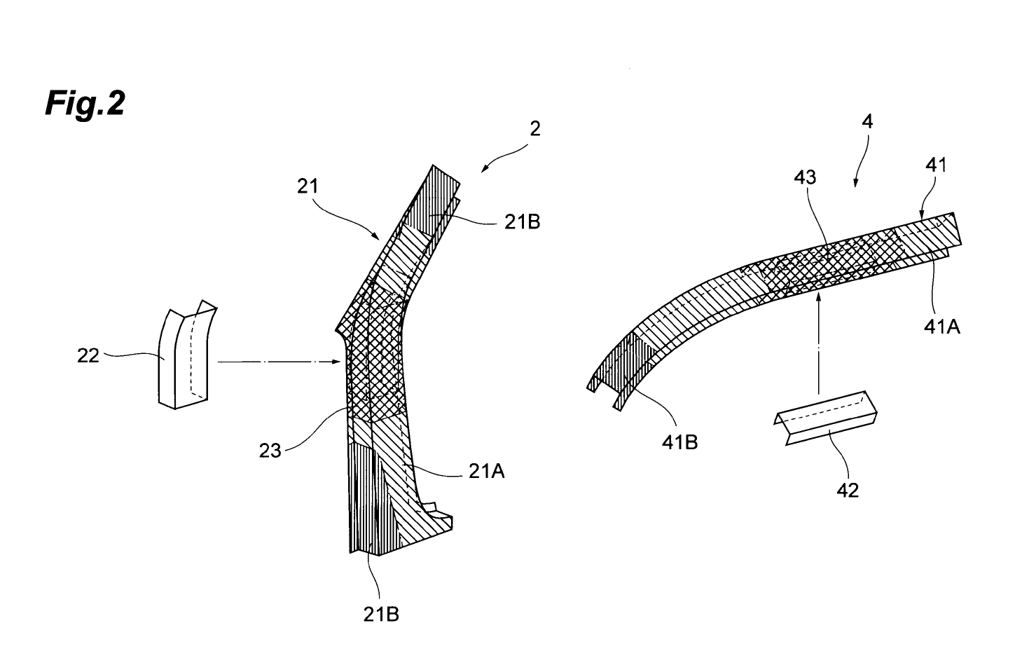

As shown in FIG. 2, the front pillar 2 includes a front pillar outer reinforcement (hereinafter referred to as “R/F”) 21 and a front pillar patch R/F 22 that becomes a first reinforcing portion is disposed inside a belt line portion in the front pillar outer R/F 21. Additionally, the front pillar outer R/F 21 is formed with a high-strength portion 21A that becomes a third reinforcing portion, and a low-strength portion 21B that becomes a weakened portion.

The high-strength portion 21A is a portion to which strength is imparted by performing quenching a front pillar outer R/F matrix. The quenching for forming the high-strength portion 21A can also be performed before molding of a front pillar outer R/F matrix or can also be performed after molding of the matrix. The portion on which this quenching is performed becomes the high-strength portion 21A, whereas portions other than the portion formed with the high-strength portion 21A becomes the low-strength portion 21B. The low-strength portion 21B is heat-treated according to different heat-treatment conditions from the heat-treatment conditions when the high-strength portion 21A is formed, and is worked so as to have lower strength than the high-strength portion 21A.

The high-strength portion 21A is formed over the entire range excluding an upper end and a lower end front portion in the front pillar outer R/F 21. On the contrary, the upper end and the lower end front portion in the front pillar outer R/F 21 become the low-strength portion 21B. The high-strength portion 21A extends to a portion just before a connecting portion of the upper end of the front pillar outer R/F 21 joined to the roof side rail 4, and the connecting portion of the upper end of the front pillar outer R/F 21 joined to the roof side rail 4 is formed into the low-strength portion 21B. Additionally, at the lower end in the front pillar outer R/F 21, a front range is formed into the low-strength portion 21B, and a rear range is formed into the high-strength portion 21A.

Moreover, the front pillar outer R/F 21 is formed with a high plate-thickness portion 23 that becomes a second reinforcing portion. The high plate-thickness portion 23 is formed in a region including the portion of the front pillar outer R/F 21 provided with the front pillar patch R/F 22. The high plate-thickness portion 23 is formed by, for example, TWB (tailored blank) working. In the TWB, the strength in a part is changed by laser-joining and molding materials having different plate-thickness and material in the state of a raw material sheet.

Through such a configuration, the center pillar patch R/F 22 is provided as the first reinforcing portion at the belt line portion of the front pillar outer R/F 21 in the front pillar 2. Additionally, the high plate-thickness portion 23 is formed as the second reinforcing portion over a region broader than a region including the center pillar patch R/F 22. Moreover, the high-strength portion 21A is formed as the third reinforcing portion over a region broader than a region including the high plate-thickness portion 23.

To simply describe the process of manufacturing the front pillar 2, first, a front pillar outer R/F matrix is prepared, and the front pillar patch R/F 22 is disposed at a belt line portion of the front pillar outer R/F matrix. Next, a region including the portion of the front pillar outer R/F matrix where the front pillar patch R/F 22 is disposed is subjected to TWB working so as to form the high plate-thickness portion 23. Thereafter, heat treatment is performed under predetermined heat-treatment conditions so as to form the high-strength portion 21A and the low-strength portion 21B and form the front pillar outer R/F 21. The front pillar 2 is manufactured in this way.

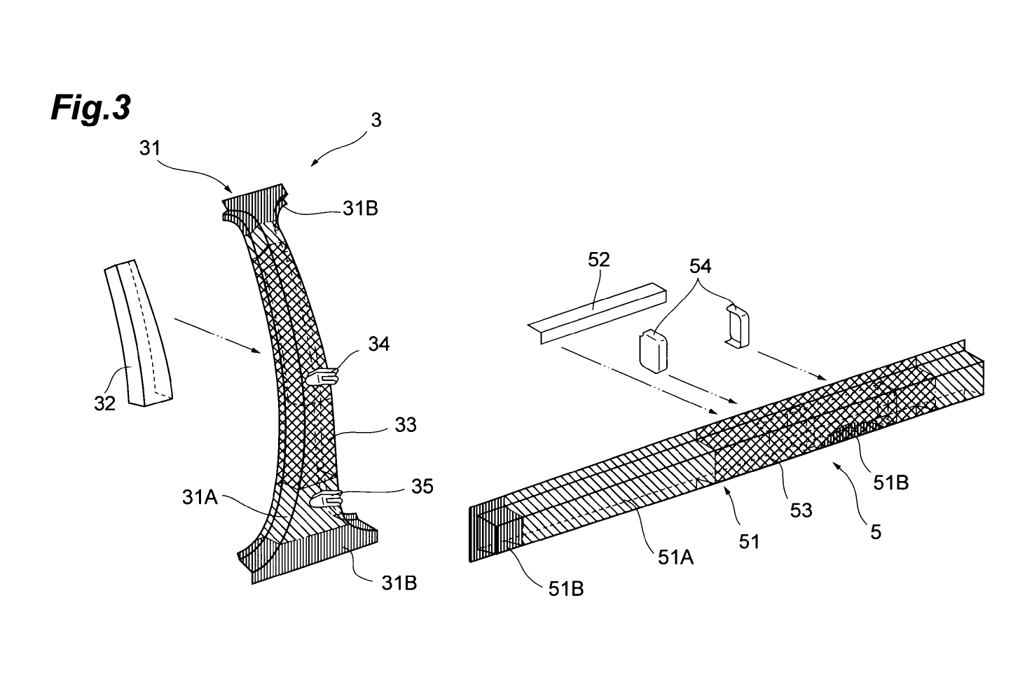

As shown in FIG. 3, the center pillar 3 includes a center pillar outer R/F 31, and a center pillar patch R/F 32 is disposed inside a belt line portion in the center pillar outer R/F 31. Additionally, the center pillar outer R/F 31 is formed with a high-strength portion 31A and a low-strength portion 31B. The high-strength portion 31A and the low-strength portion 31B are formed similarly to the high-strength portion 21A and the low-strength portion 21B formed in the front pillar outer R/F 21.

The high-strength portion 31A is formed over the entire range excluding an upper end and a lower end in the center pillar outer R/F 31. On the contrary, the upper end and the lower end in the center pillar outer R/F 31 become the low-strength portion 31B. The high-strength portion 31A extends to a portion just before a connecting portion of the upper end of the center pillar outer R/F 31 joined to the roof side rail 4, and the connecting portion of the upper end of the center pillar outer R/F 31 joined to the roof side rail 4 is formed into the low-strength portion 31B. Additionally, the high-strength portion 31A extends to a portion just before a connecting portion of the lower end of the center pillar outer R/F 31 joined to the side sill 5, and the connecting portion of the lower end of the center pillar outer R/F 31 joined to the side sill 5 is formed into the low-strength portion 31B.

Moreover, the center pillar outer R/F 31 is formed with a high plate-thickness portion 33. The high plate-thickness portion 33 is formed in a region including the portion of the center pillar outer R/F 31 provided with the center pillar patch R/F 32. The high plate-thickness portion 33 in the center pillar outer R/F 31 is formed by, for example, TWB working similarly to the front pillar outer R/F 21.

Additionally, the center pillar outer R/F 31 is provided with an upper hinge 34 and a lower hinge 35. A lower end of the high plate-thickness portion 33 is located on the upper side of the lower hinge 35 below a lower end of the center pillar patch R/F 32. Moreover, a lower end of the high-strength portion 31A is located below the lower hinge 35.

To simply describe the process of manufacturing the center pillar 3, first, a center pillar outer R/F matrix is prepared, and the center pillar patch R/F 32 is disposed at a belt line portion of the center pillar outer R/F matrix. Next, a region including the portion of the center pillar outer R/F matrix where the center pillar patch R/F 32 is disposed is subjected to TWB working so as to form the high plate-thickness portion 33. Thereafter, heat treatment is performed under predetermined heat-treatment conditions so as to form the high-strength portion 31A and the low-strength portion 31B and form the center pillar outer R/F 31. The center pillar 3 is manufactured in this way.

As shown in FIG. 2, the roof side rail 4 includes a roof side rail outer R/F 41, and a roof side rail patch R/F 42 is disposed inside a longitudinal middle position of the roof side rail outer R/F 41. Additionally, the roof side rail outer R/F 41 is formed with a high-strength portion 41A and a low-strength portion 41B. The high-strength portion 41A and the low-strength portion 41B are formed similarly to the high-strength portion 21A and the low-strength portion 21B formed in the front pillar outer R/F 21.

The high-strength portion 41A is formed over the entire range excluding a front end in the roof side rail outer R/F 41. On the contrary, the front end in the roof side rail outer R/F 41 becomes the low-strength portion 41B. The high-strength portion 41A extends to a portion just before a connecting portion of the front end of the roof side rail outer R/F 41 joined to the front pillar 2, and the connecting portion of the front end of the roof side rail outer R/F 41 joined to the front pillar 2 is formed into the low-strength portion 41B.

Moreover, the roof side rail outer R/F 41 is formed with a high plate-thickness portion 43. The high plate-thickness portion 43 is formed in a region including the portion of the roof side rail outer R/F 41 provided with the roof side rail patch R/F 42. The high plate-thickness portion 43 in the roof side rail outer R/F 41 is formed by, for example, TWB working similarly to the front pillar outer R/F 21.

Additionally, a connecting portion at the upper end of the center pillar 3 is joined to the roof side rail 4. Both of the roof side rail patch R/F 42 and the high plate-thickness portion 43 in the roof side rail 4 are arranged with the connecting portion at the upper end of the center pillar 3 as a center.

To simply describe the process of manufacturing the roof side rail 4, first, a roof side rail outer R/F matrix is prepared, and the roof side rail patch R/F 42 is disposed at a substantially longitudinal central portion of the roof side rail outer R/F matrix. Next, a region including a portion where the roof side rail patch R/F 42 in the roof side rail outer R/F matrix is disposed is subjected to TWB working so as to form the high plate-thickness portion 43. Thereafter, heat treatment is performed under predetermined heat-treatment conditions so as to form the high-strength portion 41A and the low-strength portion 41B and form the roof side rail outer R/F 41. The roof side rail 4 is manufactured in this way.

As shown in FIG. 3, the side sill 5 includes a side sill outer R/F 51, and a side sill patch R/F 52 is disposed inside a longitudinal middle position of the side sill outer R/F 51. Additionally, the side sill outer R/F 51 is formed with a high-strength portion 51A and a low-strength portion 51B. The high-strength portion 51A and the low-strength portion 51B are formed similarly to the high-strength portion 21A and the low-strength portion 21B formed in the front pillar outer R/F 21.

The high-strength portion 51A is formed over the entire range excluding a front portion and a lower portion at the longitudinal middle position in the center pillar outer R/F 51. On the contrary, the upper end and a lower portion at the longitudinal middle position in the center pillar outer R/F 51 become the low-strength portion 51B. On the upper side of the side sill 5, the high-strength portion 51A extends to a front end of the side sill outer R/F 51, i.e., a position where the front pillar 2 is joined. Additionally, on the upper side of the side sill 5, in addition to the front end, a position excluding the longitudinal middle position is formed into the high-strength portion 51A.

Moreover, a portion of the front end of the side sill outer R/F 51 where the front pillar 2 is joined, and a longitudinal middle position on the lower side of the side sill 5 is formed into the low-strength portion 51B. Among these, the width of the low-strength portion 51B in the front-back direction formed at the front end of the side sill outer R/F 51 is made approximately equal to the width of the low-strength portion 31B in the front-back direction and formed at the lower end of the center pillar outer R/F 31.

On the other hand, the connecting portion of the center pillar 3 is joined to a portion just above the longitudinal middle position of the side sill 5 that is formed into the low-strength portion 51B. The low-strength portion 51B formed at the lower portion of the side sill 5 at the longitudinal middle position is formed in an upwardly convex semicircular shape in side view. Additionally, the peak of the low-strength portion 51B is a height position that is equal to or less than ½ of the cross-sectional height of the side sill outer R/F 51, and the lower end of the center pillar 3 is located at a position higher than the low-strength portion 51B.

Moreover, the side sill outer R/F 51 is formed with a high plate-thickness portion 53. The high plate-thickness portion 53 is formed in a region including a portion provided with the side sill patch R/F 52 in the side sill outer R/F 51. The high plate-thickness portion 53 in the side sill outer R/F 5 is formed by, for example, TWB working similarly to the front pillar outer R/F 21.

Additionally, a connecting portion at the lower end of the center pillar 3 is joined to the side sill 5. Both the side sill patch R/F 52 and the high plate-thickness portion 53 in the side sill 5 are arranged with the connecting portion at the lower end of the center pillar 3 as a center. Moreover, a bulk head 54 is provided inside a position where the high plate-thickness portion 53 in the side sill outer R/F 51 is formed.

To simply describe the process of manufacturing the side sill 5, first, a side sill outer R/F matrix is prepared, and the side sill outer R/F matrix is heat-treated under predetermined heat-treatment conditions so as to form the high-strength portion 51A and the low-strength portion 51B and form the side sill outer R/F 51. At this time, the low-strength portion 51B is formed at the tip portion of the side sill outer R/F 51 and a lower portion of a substantially longitudinal center. The low-strength portion 51B at the front end of the side sill outer R/F 51 is formed at a position that is continuous with the low-strength portion 21B formed at the lower end of the front pillar outer R/F 21 when the front pillar 2 is joined.

Subsequently, the bulk head 54 is disposed at a position where the low-strength portion 51B is pinched, inside the side sill outer R/F 51. At this time, the bulk head 54 is arranged along a front-back ridgeline of the connecting portion in the center pillar 3 joined to the side sill outer R/F 51. Thereafter, a region including the bulk head 54 is subjected to TWB working so as to form the high plate-thickness portion 53. Therefore, a portion of the low-strength portion 51B becomes the high plate-thickness portion 53. The side sill patch R/F 52 is disposed above the low-strength portion 51B in the high plate-thickness portion 53 so as to manufacture the side sill 5.

In the vehicle body structure 1 related to the present embodiment having the above configuration, the center pillar 3, the roof side rail 4, and the side sill 5 in addition to the front pillar 2 are reinforced by the patch R/Fs, the high plate-thickness portions, the high-strength portions, and the like. For this reason, the front pillar 2, the center pillar 3, the roof side rail 4, and the side sill 5 can be reinforced at desired positions.

Additionally, in the front pillar 2, first reinforcement is made by the front pillar patch R/F 22. Additionally, second reinforcement is made by the high plate-thickness portion 23 including a region where the front pillar patch R/F 22 is provided. Moreover, third reinforcement is made by the high-strength portion 21A including a region where the high plate-thickness portion 23 is formed. Additionally, the same reinforcement is made even in the center pillar 3, the roof side rail 4, and the side sill 5 and in addition to the front pillar 2.

In the front pillar 2, the center pillar 3, the roof side rail 4, and the side sill 5, the first reinforcement to the third reinforcement are gradually made in this way. For this reason, the number of parts for reinforcement can be efficiently reduced. As a result, the strength at desired positions in skeleton constituent members can be increased and shock-absorbing performance can be improved, more appropriately without causing an increase in the weight of the vehicle.

Moreover, for example, the low-strength portions 21B and 41B are provided at a joining portion of the front pillar 2 with the roof side rail 4 and at a joining portion of the roof side rail 4 with the front pillar 2. For this reason, a portion between skeleton constituent members, such as between the front pillar 2 and the roof side rail 4 can be stably deformed. Moreover, even when skeleton constituent members have complicated shapes, a weakened portion can be easily formed.

Next, an example of the structure and modified form of respective skeleton constituent members when a collision occurs in a vehicle will be described.

In the front pillar 2, the belt line portion of the front pillar outer R/F 21 is provided with the front pillar patch R/F 22. Additionally, the high plate-thickness portion 23 is formed within a range including a region where the front pillar patch R/F 22 is provided. Moreover, the high-strength portion 21A is formed within a range including the region of the front pillar outer R/F 21 where the high plate-thickness portion 23 is formed. For this reason, the distribution of strength that decreases in three steps in the vertical direction with the belt line portion of the front pillar outer R/F 21 as a peak is realized by the configuration of simple parts. For this reason, a structure that develops high strength with respect to a bending moment caused by a load applied to the belt line portion of the front pillar outer R/F 21 can be manufactured without waste.

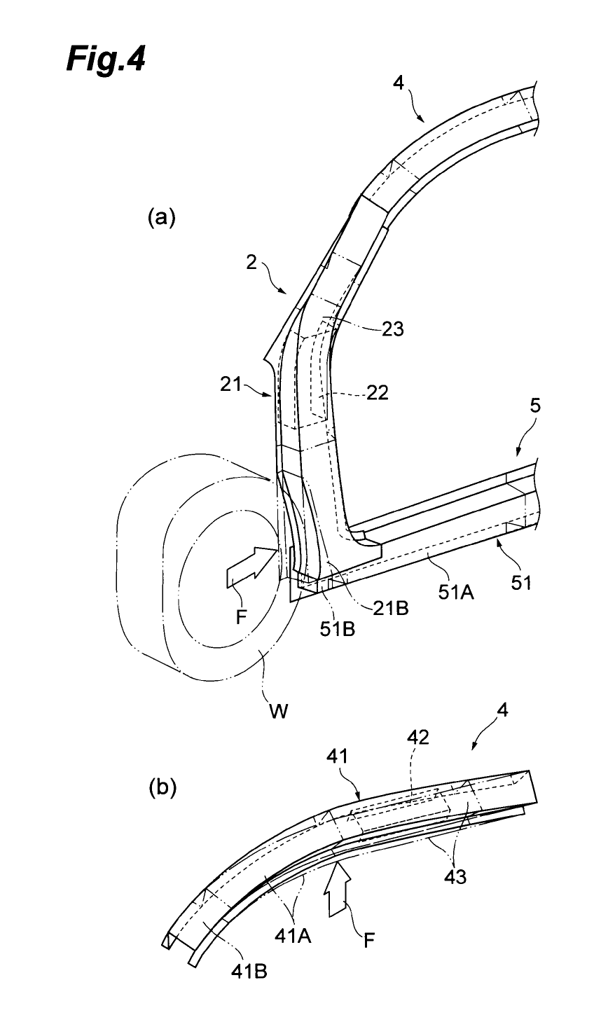

Moreover, the joining portion of the front pillar 2 with the roof side rail 4 is formed with the low-strength portion 21B. For this reason, as shown in FIG. 4A, the low-strength portion 21B in the joining portion of the front pillar 2 with the roof side rail 4 can be stably deformed with respect to an overload input F in the front-back direction of the vehicle. Accordingly, deformation of a cabin portion in the vehicle can be suppressed to be small.

Moreover, in a lower portion of the front pillar 2, a vehicle rear is formed into the high-strength portion 21A, and a vehicle front is formed into the low-strength portion 21B. For this reason, when a front collision occurs in the vehicle and a front wheel W and the front pillar 2 interfere with each other, a lower front portion of the front pillar 2 can be deformed to appropriately perform energy absorption.

In the center pillar 3, the belt line portion of the center pillar outer R/F 31 is provided with the center pillar patch R/F 32. Additionally, the high plate-thickness portion 33 is formed within a range including a region where the center pillar patch R/F 32 is provided, and the lower end of the high plate-thickness portion 33 is arranged on the lower side of the center pillar patch R/F 32. Moreover, the high-strength portion 31A is formed within a range including a region where the high plate-thickness portion 33 is formed. Additionally, in the relationship with the lower hinge 35, the lower end of the high plate-thickness portion 33 is arranged above the lower hinge 35, and the lower end of the high-strength portion 31A is arranged below the lower hinge 35.

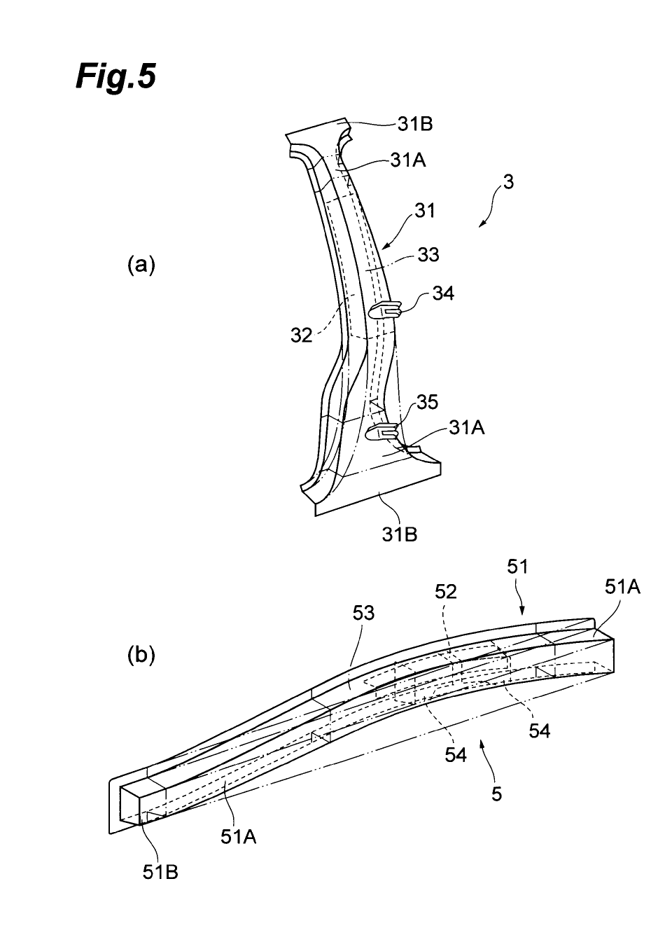

Through such a configuration, the distribution of strength that decreases in three steps in the vertical direction with the belt line portion of the center pillar outer R/F 31 as a peak is realized by the configuration of simple parts. For this reason, as shown in FIG. 5A, when a side collision occurs in the vehicle, the center pillar outer R/F 31 can be deformed in two steps sequentially from the lower portion of the center pillar outer R/F 31. As a result, since a rise in moment can be suppressed, entering of the center pillar 3 to an occupant cabin can be suppressed.

Moreover, the upper end of the center pillar outer R/F 31 is a connecting portion with the roof side rail 4, and this connecting portion is formed into the low-strength portion 31B. Additionally, the center pillar outer R/F 31 is formed into the high-strength portion 31A at a position lower than the connecting portion of the roof side rail 4. Although the shape of the connecting portion of the center pillar outer R/F 31 with the roof side rail 4 becomes complicated, the connecting portion with the roof side rail 4 is formed into the low-strength portion 31B, so that trimming after molding can be easily performed.

In the roof side rail 4, the roof side rail patch R/F 42 is provided around the joining portion of the roof side rail outer R/F 41 with the center pillar 3. Additionally, the high plate-thickness portion 43 is formed within a range including a region where the roof side rail patch R/F 42 is provided. Moreover, the high-strength portion 41A is formed within a range including the region of the roof side rail outer R/F 41 where the high plate-thickness portion 43 is formed. For this reason, the distribution of strength that decreases in three steps in the front-back direction of the vehicle with the joining portion with the center pillar 3 as a peak is realized by the configuration of simple parts. For this reason, as shown in FIG. 4B, a structure that develops high strength with respect to a bending moment caused by an overload input F applied from the center pillar 3 can be manufactured without waste.

Additionally, the tip portion of the roof side rail outer R/F 41 is a connecting portion with the front pillar 2, and this connecting portion is formed into the low-strength portion 41B. Additionally, the high-strength portion 41A is formed into the roof side rail outer R/F 41 at a position behind the connecting portion with the front pillar 2. For this reason, as shown in FIG. 4A, the low-strength portion 41B in the joining portion of the roof side rail 4 with the front pillar 2 can be stably deformed with respect to an overload input F in the front-back direction of the vehicle. Accordingly, deformation of a cabin portion in the vehicle can be suppressed to be small.

In a lower portion of a cross-section of the joining portion of the side sill 5 with the center pillar 3, the semi-circular low-strength portion 51B that is upwardly convex in side view around the central portion, in the front-back direction, of the joining portion with the center pillar 3. Additionally, the peak of the low-strength portion 51B is equal to or less than ½ of the cross-sectional height in the side sill 5, and is located below the lower end of the center pillar 3. For this reason, the center pillar 3 can be stably deformed with respect to a load in a right-and-left direction applied to the joining portion with the center pillar 3.

Additionally, the bulk head 54 is provided at a position along the front-back ridgeline of the connecting portion in the center pillar 3, inside the cross-section of the side sill 5 that pinches both sides of the low-strength portion 51B. For this reason, when the lower portion of the center pillar 3 is deformed, it is possible to suppress progressing of the joining portion between the center pillar 3 and the side sill 5 to the outside. Accordingly, the side sill 5 functions as a beam that has a plastic joint at the lower portion of the center pillar 3. As a result, a bending moment that acts on the side sill 5 can be reduced.

Moreover, the lower portion of the center pillar 3 may be supported by other skeleton constituent members, such as a floor cross. In such a case, the side sill 5 functions as two short beams that are independent in front of and behind the center pillar 3. For this reason, the bending deformation of the center pillar 3 can be appropriately suppressed.

Additionally, the low-strength portion 51B at the front end of the side sill outer R/F 51 is formed at a position that is continuous with the low-strength portion 21B formed at the lower end of the front pillar outer R/F 21 when the front pillar 2 is joined. Other portions in the side sill outer R/F 51 are formed into the high-strength portion 51A. For this reason, as shown in FIG. 4A, when a front collision occurs in the vehicle and the front wheel W and the front pillar 2 interfere with each other, only a front portion of the side sill 5 can be deformed. As a result, energy absorption can be appropriately performed, maintaining the reaction force of the side sill 5.

Moreover, in the side sill 5, the high-strength portion 51A is formed within a range including a region where the bulk head 54 is provided. Additionally, the side sill patch R/F 52 is provided on the upper side of the low-strength portion 51B. For this reason, as shown in FIG. 5B, when a side collision occurs in the vehicle, the cross-section of the lower portion of the joining portion with the center pillar 3 can be buckled. Moreover, the deformation position of the side sill 5 can be limited to the vicinity of the position of joining with the center pillar 3. Accordingly, the twist mode of the side sill 5 can be suppressed, and the deformation amount of the side sill 5 can be minimized. In this way, the deformation mode of the side sill 5 can be further stabilized.

Although a preferred embodiment of the invention has been described, the present invention is not limited to the above embodiment. For example, although three steps of strength distributions by forming the patch R/Fs, the high plate-thickness portions, and the high-strength portions are provided in the above embodiment, the patch R/Fs, the high plate-thickness portions, and the high-strength portions can be replaced, or strength can also be imparted in other ways. Additionally, the strength distribution can also be not three steps but two steps or four steps or more.

### INDUSTRIAL APPLICABILITY

The present invention can be used for a vehicle body structure pertaining to a skeletal structure of a vehicle.

### REFERENCE SIGNS LIST

1: VEHICLE BODY STRUCTURE
2: FRONT PILLAR
3: CENTER PILLAR
4: ROOF SIDE RAIL
5: SIDE SILL
21: FRONT PILLAR OUTER R/F
21A: HIGH-STRENGTH PORTION
21B: LOW-STRENGTH PORTION
22: FRONT PILLAR PATCH R/F
23: HIGH PLATE-THICKNESS PORTION
31: CENTER PILLAR OUTER R/F
31A: HIGH-STRENGTH PORTION
31B: LOW-STRENGTH PORTION
32: CENTER PILLAR PATCH R/F
33: HIGH PLATE-THICKNESS PORTION
34: UPPER HINGE
35: LOWER HINGE
41: ROOF SIDE RAIL OUTER R/F
41A: HIGH-STRENGTH PORTION
41B: LOW-STRENGTH PORTION
42: ROOF SIDE RAIL PATCH R/F
43: HIGH PLATE-THICKNESS PORTION
51: SIDE SILL OUTER R/F
51A: HIGH-STRENGTH PORTION
51B: LOW-STRENGTH PORTION
52: SIDE SILL PATCH R/F
53: HIGH PLATE-THICKNESS PORTION
54: BULK HEAD
F: OVERLOAD INPUT
W: FRONT WHEEL

1. A vehicle body structure comprising:
a skeleton constituent member that constitutes a vehicle body skeleton, a reinforcing portion being formed at an intermediate portion of the skeleton constituent member,
wherein the skeleton constituent member is reinforced over a region including the reinforcing portion and broader than the reinforcing portion, and
wherein the strength of the skeleton constituent member has a strength distribution that changes in a plurality of steps.

2. The vehicle body structure according to claim 1, further comprising:
a first reinforcing portion formed at the intermediate portion of the skeleton constituent member;
a second reinforcing portion formed over a region including a first reinforcing portion forming region formed with the first reinforcing portion and broader than the first reinforcing portion forming region; and
a third reinforcing portion formed over a region including a second reinforcing portion forming region formed with the second reinforcing portion and broader than the second reinforcing portion forming region.

3. The vehicle body structure according to claim 2,
wherein the first reinforcing portion is reinforced by providing a reinforcing member, the second reinforcing portion is reinforced by making the plate-thickness thereof larger than that of other portions, and the third reinforcing portion is reinforced by heat treatment.

4. The vehicle body structure according to claim 1,
wherein the skeleton constituent member includes a plurality of portions, and
a weakened portion is formed at a joining portion between one skeleton constituent member and another skeleton constituent member.

5. The vehicle body structure according to claim 1,
wherein the skeleton constituent member includes a front pillar and a side sill, and
a weakened portion is formed in a region covering both members of the front pillar and the side sill on the vehicle front side.

6. The vehicle body structure according to claim 1,
wherein the skeleton constituent member includes a center pillar and a side sill, and
a weakened portion is formed on the vehicle body lower side of a region of the side sill where the center pillar is disposed.

7. The vehicle body structure according to claim 3,
wherein the first reinforcing portion is further reinforced by making the plate-thickness thereof larger than that of other portions and by heat treatment, and the second reinforcing portion is further reinforced by heat treatment.
